(19) United States
(12) Patent Application Publication
(10) Pub. No.: US 2008/0089526 A1
(43) Pub. Date: Apr. 17, 2008

(54) Method for estimating an interference field for a coil

(75) Inventors: Peter Nikles, Erlangen (DE); Marius Radick, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Audiologische Technik GmbH

(21) Appl. No.: 11/974,882

(22) Filed: Oct. 16, 2007

Related U.S. Application Data
(60) Provisional application No. 60/852,099, filed on Oct. 16, 2006.

(51) Int. Cl. H04R 29/00

(52) U.S. Cl. 381/60

(57) ABSTRACT

The invention relates to a method for estimating an interference field for a real coil of a hearing apparatus comprising: simulating a field distribution of the interference field; calculating an interference field size for a number of coil segments of a virtual coil representing the real coil at a predetermined location and a predetermined orientation in the interference field; calculating an overall interference field size of the virtual coil with an individual, modifiable weight being applied to the interference field sizes of the coil segments; measuring a field size of the real coil at the predetermined location and the predetermined orientation; adapting the weights based on a comparison between the measured field size and the calculated overall interference field size for a rapid, calibrated estimation or calculation of the interference field.

### CROSS REFERENCE TO RELATED APPLICATIONS

The present application claims the benefit of the provisional patent application filed on Oct. 16, 2006, and assigned application No. 60/852,099, and is incorporated by reference herein in its entirety.

### FIELD OF THE INVENTION

The present invention relates to a method for estimating an interference field for a real coil of a hearing apparatus. The term hearing apparatus here is especially understood as a hearing device, a headset or an earpiece.

### BACKGROUND OF THE INVENTION

Hearing devices are wearable hearing apparatus used to assist the hard-of-hearing. To meet the numerous individual requirements different designs of hearing device are provided, such as behind-the ear (BTE) hearing devices, in-the-ear (ITE) hearing devices and Concha hearing devices. The typical configurations of hearing device are worn on the outer ear or in the auditory canal. Above and beyond these designs however there are also bone conduction hearing aids, implantable or vibro-tactile hearing aids available on the market. In such hearing aids the damaged hearing is simulated either mechanically or electrically.

Hearing devices principally have as their main components an input converter, an amplifier and an output converter. The input converter is as a rule a sound receiver, e.g. a microphone, and/or an electromagnetic receiver, e.g. an induction coil. The output converter is mostly implemented as an electroacoustic converter, e.g. a miniature loudspeaker or as an electromechanical converter, e.g. bone conduction earpiece. The amplifier is usually integrated into a signal processing unit. This basic structure is shown in FIG. 1 using a behind-the ear hearing device as an example. One or more microphones 2 for recording the sound from the surroundings are built into a hearing device housing 1 worn behind the ear. A signal processing unit 3, which is also integrated into the hearing device housing 1, processes the microphone signals and amplifies them. The output signal of the signal processing unit 3 is transmitted to a loudspeaker or earpiece 4 which outputs the acoustic signal. The sound is transmitted, if necessary via a sound tube which is fixed with an otoplastic in the auditory canal, to the hearing device wearer's eardrum. The power is supplied to the hearing device and especially to the signal processing unit 3 by a battery 5 also integrated into the hearing device housing 1.

When inductive transmission components are used in hearing systems it is necessary to keep the influence of internal faults caused by the system itself low. The inductive transmission component can only receive external signals of which the signal strength exceeds that of the internal interference signals. A typical source of such internal faults is the earpiece embodied as a magnetic converter which emits strong inductive signals. Further fault sources are the supply leads to the earpiece, but also the different energy feeds for hearing device electronics, which from the current flow must be viewed as inductive antennas. At the location of an antenna coil of a wireless transmission system, which uses the inductive or also typically the RF range, the overlay of numerous faults is usually received.

Previously a faceplate of an ITE hearing device has generally been produced as a module with an integrated antenna coil. This means that the position of the coil is predetermined apart from small deviations and more or less large faults must be taken into account. The position of the coil must therefore be determined and optimized by complex measurements. In a so-called “semi-modular” construction the coil is not mounted directly on the faceplate and can be placed individually in the hearing device shell. The faults can be reduced in this way but the complex measurements for determining the individual position of the coil remain.

Because of their size and spatial extent there are not many options for placing an antenna coil in the hearing device. These physical restrictions can for example be determined and taken into account with the aid of collision clouds. However the influence of interference fields on the antenna coil remains unconsidered here.

A method for measuring an electrical current generated in a living organ is known from publication DE 42 26 413 A1. In this case a plurality of pick-up coils which are positioned at detection points are used for measurement of magnetic field strengths. At interpolated or extrapolated detection points the magnetic field strengths at these points are estimated.

### SUMMARY OF THE INVENTION

The object of the present invention is to estimate an interference field which can give rise in a coil of a hearing apparatus to corresponding faults, before the absolute positioning of the coil is decided, or to be able to calculate this field.

Inventively this object is achieved by a method for estimating an interference field for a real coil of a hearing apparatus by providing a simulated field distribution of the interference field, calculating an interference field size for each of a number of coil segments of a virtual coil representing the real coil at a predetermined location and a predetermined orientation of the virtual coil in the interference field, calculating an overall interference field size of the virtual coil at the predetermined location and the predetermined orientation, with an individual modifiable weight being applied to each interference field size of the number of coil segments, measuring a field size corresponding to the overall field size of the real coil with the real coil at the predetermined location with the predetermined orientation in the interference field, adapting the individual weights as a function of the comparison between the measured field size and the calculated overall interference field size and calculating the overall interference field size for another location and another orientation of the virtual coil as estimation of the interference field there on the basis of the adapted individual weights.

Advantageously the estimation of the interference field can be executed in a simple manner for a specific location and for a specific orientation of the coil in the hearing device. A corresponding, complete simulation inclusive of the coil, with the complexity of a coil (very high segmentation effort in the conventional simulation software) would mean a very long processing time. To design a high-quality estimation process, a calibration is undertaken with the aid of empirical measurements. Depending on the desired accuracy correspondingly many measurement points can be included for the calibration.

In accordance with a specific embodiment the field size is measured indirectly by a voltage at the real coil measured and for the adaptation of the individual weights either the overall field size is converted into a virtual voltage or the measured voltage is converted into a corresponding field size. This makes it easy for the voltage present at the real coil and produced by the interference field to be tapped and included for the calibration.

It is also advantageous for a three-dimensional, simulated field distribution of the interference field to be provided and for the overall field size to be determined by layered calculation of corresponding 2D components in the virtual coil. The complexity of the interference calculation can be greatly reduced in this way.

For the estimation of the interference field the virtual coil can for example be divided up into two, three or four segments. Naturally it is also possible to divide up the coil into further segments if the accuracy of the calibration demands this.

The inventive method can be performed for a number of locations and/or orientations of the virtual and real coil in the interference field. At the end of these estimations or calculations respectively an optimum location for the coil in the hearing apparatus can then be determined or predicted respectively.

The inventive method can be employed especially advantageously to estimate the interference field for the conditions in a hearing device housing. This enables the orientation and the location of an antenna coil of a hearing device to be optimized.

### BRIEF DESCRIPTION OF THE DRAWINGS

The present invention is explained in greater detail with reference to the enclosed drawings, which show:

FIG. 1 a schematic view of the main components of a hearing device;

FIG. 2 a two-dimensional view of an interference field with segmented virtual coil;

FIG. 3 a flow diagram for an embodiment of an inventive method for calibration of a calculation algorithm and

FIG. 4 a flowchart of a typical calculation algorithm.

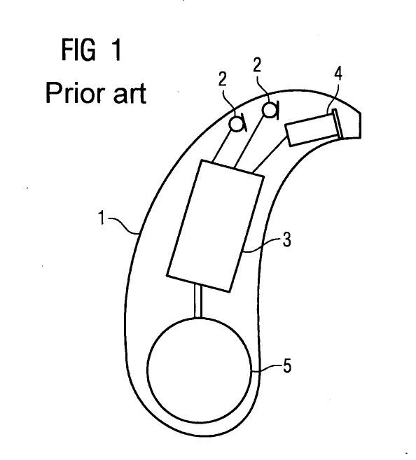

### DETAILED DESCRIPTION OF THE INVENTION

The exemplary embodiments described in greater detail below represent preferred embodiments of the present invention.

The interference field which acts on a coil, is basically embodied as a three-dimensional field. However in order to keep the complexity of the calculation of the interference field as low as possible a 2D calculation approach is selected. In this case the three-dimensional dataset of a field simulation is subdivided into planes of intersection. The basic assumption is also made that the magnetic flux is primarily carrier near to the core center point of the coil. The volume of the coil is represented by the maximum surface of the coil within the respective plane of intersection.

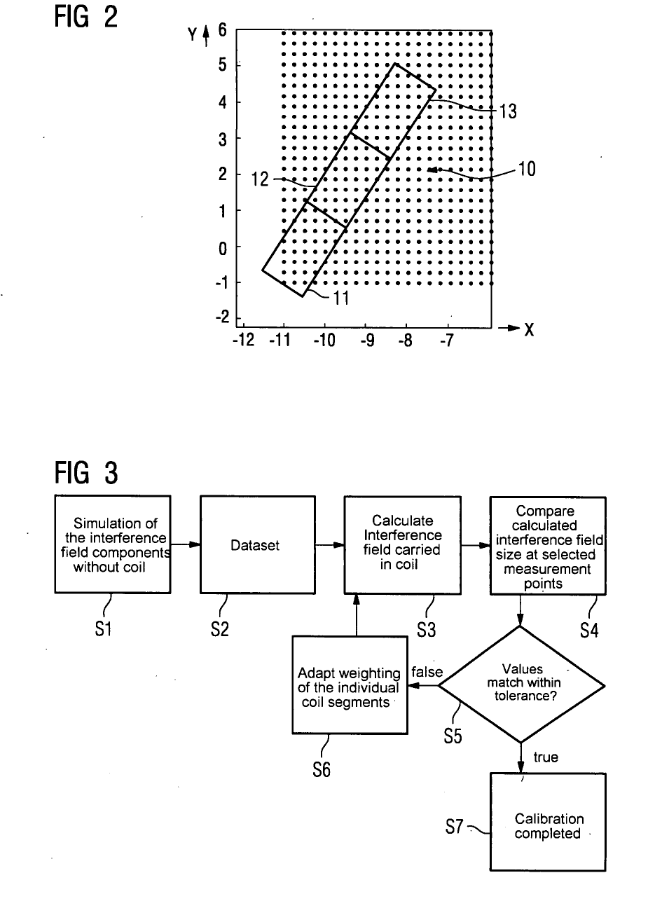

FIG. 2 shows a schematic diagram of a plane of intersection of an interference field. The points in each case represent a data point (field component, phase) of the simulation of the interference field. The coil in the interference field is represented by a rectangle 10. It is divided up here into three segments 11, 12 and 13 of equal size. This segmentation allows the coupling-in behavior of the virtual coil to be described more precisely, since the individual segments 11, 12, 13 can be weighted to calibrate the calculation on the basis of individual measurements. Subsequently the result is normalized.

In the concrete example shown in FIG. 2 the virtual coil has been placed at the location x=−11 and y=−1 at an angle of inclination of 30 degrees. The position of the virtual coil in the interference field is uniquely defined in this way. In a next step the data points which lie within a specific segment 11, 12 or 13 are then identified. The individual points then define the contribution of each segment to the overall fault generated in the coil. With a sufficiently small grid spacing of the simulation field image the field strength coupled into the coil can be defined sufficiently precisely.

From a single simulation dataset field strengths carried in the coil can quickly be calculated for all coil angles and variable coil geometries (length, diameter). In this way “collision clouds” can be determined which relate to electromagnetic interference or interactions respectively between the individual components of an ITE for example. If necessary the collision clouds can be calculated in realtime. This makes it possible to visualize interactively improvements in the cabling or the construction, not just of hearing devices.

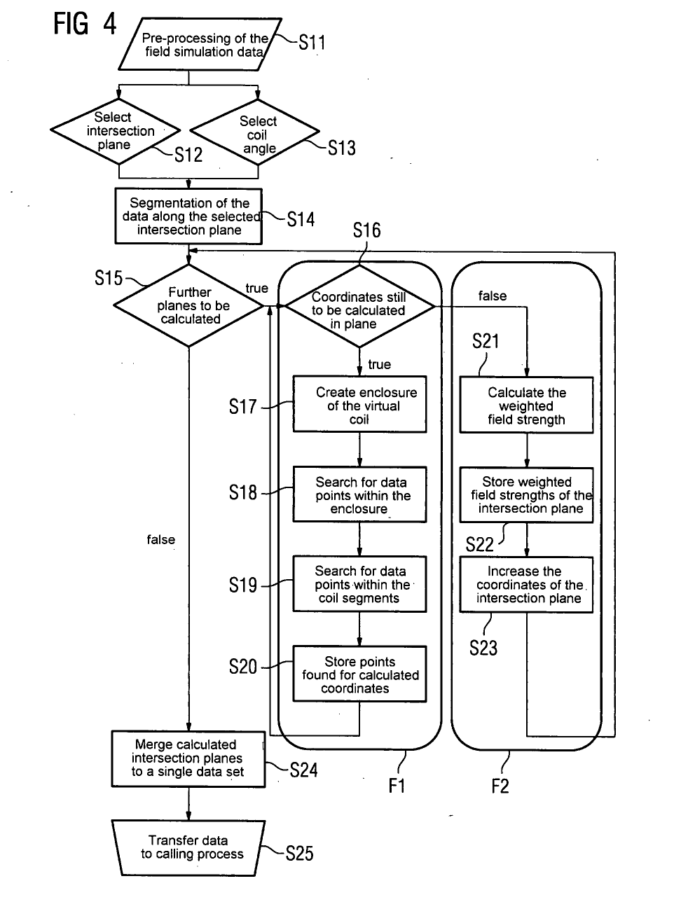

The calibration of the calculation algorithm is shown in greater detail in FIG. 3. Accordingly the interference field components without coil are first simulated according to step S1. A dataset for the field distribution is obtained from this in accordance with step 2. Then, from this dataset, as was indicated in conjunction with FIG. 2, the interference field size carried into the coil is calculated in accordance with step S3. The precise execution of the calculation is explained in more detail below in conjunction with FIG. 4.

The calibration, as mentioned above, requires the measurement of the interference field of its effect with a real coil respectively. Measurements are taken for this purpose at selected measuring points. In accordance with step S4 the interference field size calculated for the respective measuring point in step S3 is then compared with the measurement. If the values from calculation or estimation and measurement respectively do not match and also do not match within a prespecified tolerance, which is checked in step S5, the weights of the individual coil segments are adapted in accordance with step S6. The new weights are used to calculate the interference field size in the virtual coil in step S3.

The calibration loop S3 to S6 is run until such time as it is established in step S5 that the calculated and measured values are within the tolerance demanded. The routine then exits from the calibration loop and the calibration is concluded in accordance with step S7.

In FIG. 4 the step of S3, i.e. the calculation of the interference field size, is shown schematically in a flowchart. In step S11 a preprocessing of the field simulation data obtained from step S2 is first undertaken. After the preprocessing a plane of intersection S12 and a coil angle S13 are selected for the virtual coil. Subsequently, in accordance with step S14, a segmentation of the data along the selected plane of intersection is undertaken, as can be seen for example in FIG. 2. The virtual coil will thus for example be divided into three segments in the current plane. Now a loop is run respectively (S115) for all planes of the three-dimensional field distribution. In this loop a check is first made within a subloop, whether for example even further coordinates in the plane are to be calculated for a collision cloud (S16). In FIG. 4 this subloop, with the aid of which the relevant data points are determined, is labeled F1. In this case, in an initial step S17, an enclosure of the virtual coil is created (cf. virtual coil 10 in FIG. 2). In accordance with step S18 data points are sought within the enclosure. In this case account is taken in accordance with step S19 of the coil segments within which the data points are located. The points determined are stored for the computed coordinates in step S20. The subloop, i.e. the sequence of steps S16 to S20 is repeated for as long as there are coordinates to be calculated in the plane.

If the plane is completely calculated, a function block F2 follows, in which the weighted field strengths are calculated plane-by-plane for each field segment. To this end the weighted field strength for the respective plane of intersection is calculated in step S21. The weighted field strength of the plane of intersection is stored in the subsequent step S22. The coordinates of the plane of intersection are then increased and in step S15 a new check is made as to whether further planes are to be calculated.

If all planes are calculated, in step S24 the calculated plane of intersections are merged into a single dataset. This data is finally transferred to a calling process in accordance with step S25. This calling process is for example step S4 in FIG. 3.

1.-6. (canceled)

7. A method for estimating an interference field for a real coil of a hearing apparatus, comprising:
simulating a field distribution of the interference field;
representing the real coil with a virtual coil comprising a plurality of coil segments at a predetermined location and a predetermined orientation in the interference field;
calculating a plurality of interference field sizes for the coil segments of the virtual coil;
calculating an overall interference field size of the virtual coil at the predetermined location and the predetermined orientation with individually modifiable weights being correspondingly applied to the interference field sizes of the coil segments;
measuring an interference field size of the real coil at the predetermined location and the predetermined orientation in the interference field;
adapting the weights depending on a comparison between the measured interference field size and the calculated overall field size; and
calculating a further overall field size for a further location or a further orientation of the virtual coil for estimating the interference field at the further location or the further orientation based on the adapted individual weights.

8. The method as claimed in claim 7, wherein the interference field size is measured indirectly by a voltage at the real coil and the weights are adapted by converting the calculated overall interference field size into a virtual voltage or by converting the measured voltage into the interference field size.

9. The method as claimed in claim 7, wherein the field distribution of the interference field is simulated three-dimensionally and the overall interference field size is determined by calculating a plurality of layers of two dimensional components in the virtual coil.

10. The method as claimed in claim 7, wherein the interference field is estimated for a plurality of locations or orientations of the virtual coil and the real coil in the interference field.

11. The method as claimed in claim 7, wherein the interference field is estimated in a housing of the hearing apparatus.
